(19) United States
(12) Patent Application Publication
(10) Pub. No.: US 2024/0248186 A1
(43) Pub. Date: Jul. 25, 2024

(54) LANE-BASED AUTOMATIC CALIBRATION OF LIDAR ON A VEHICLE

(71) Applicant: Atieva, Inc., Newark, CA (US)

(72) Inventors: Mo Wu, Fremont, CA (US); Sepehr Pourrezaei Khaligh, Redwood City, CA (US); Xiangqiong Shi, San Jose, CA (US); Prashant Arunapuram, San Jose, CA (US)

(21) Appl. No.: 18/329,328

(22) Filed: Jun. 5, 2023

Related U.S. Application Data
(60) Provisional application No. 63/480,755, filed on Jan. 20, 2023.

(51) Int. Cl. G01S 7/497; G01S 17/931

(52) U.S. Cl. CPC G01S 7/4972; G01S 17/931

(57) ABSTRACT

A method of calibration for a vehicle comprises: obtaining speed data from at least one vehicle controller of the vehicle during travel; determining that the speed data satisfies a speed threshold; while the speed threshold is satisfied, and from a light detection and ranging (LiDAR) of the vehicle, collecting first and second pluralities of LIDAR data frames; calculating a first yaw angle using the first plurality of LIDAR data frames; calculating a second yaw angle using the second plurality of LIDAR data frames; determining whether the first and second yaw angles satisfy a consistency criterion; in response to the consistency criterion being satisfied, determining a third yaw angle for the LiDAR using the first and second yaw angles; and calibrating the LiDAR using the third yaw angle.

### CROSS-REFERENCE TO RELATED APPLICATION

This application claims benefit, under 35 U.S.C. § 119, of U.S. Provisional Patent Application No. 63/480,755, filed on Jan. 20, 2023, entitled “LANE-BASED AUTOMATIC CALIBRATION OF LIDAR ON A VEHICLE”, the disclosure of which is incorporated by reference herein in its entirety.

### TECHNICAL FIELD

This document relates to a lane-based automatic calibration of a light detection and ranging (LiDAR) on a vehicle.

### BACKGROUND

LiDAR sensors are currently used in many Advanced Driver Assisted Systems (ADAS) and Autonomous Driving (AD) technology features. As this technology is advancing, more and more vehicles are being equipped with this sensor to reconstruct the three-dimensional environment around the vehicle using the laser scanning technology. However, LiDARs may become unaligned due to impact, installation, and/or repair works.

### SUMMARY

In an aspect, a method of calibration for a vehicle comprises: obtaining speed data from at least one vehicle controller of the vehicle during travel; determining that the speed data satisfies a speed threshold; while the speed threshold is satisfied, and from a light detection and ranging (LiDAR) of the vehicle, collecting first and second pluralities of LIDAR data frames;

calculating a first yaw angle using the first plurality of LIDAR data frames; calculating a second yaw angle using the second plurality of LIDAR data frames; determining whether the first and second yaw angles satisfy a consistency criterion; in response to the consistency criterion being satisfied, determining a third yaw angle for the LiDAR using the first and second yaw angles; and calibrating the LiDAR using the third yaw angle.

Implementations can include any or all of the following features. The method further comprises obtaining vehicle yaw rate data from the at least one vehicle controller during the travel, and determining that the vehicle yaw rate data satisfies a yaw rate threshold, wherein the first and second pluralities of LIDAR data frames are collected while also the yaw rate threshold are satisfied. In response to at least one of the speed threshold or the yaw rate threshold not being satisfied, the method further comprises discarding LiDAR data. Collecting the first and second pluralities of LIDAR data frames comprises: extracting first ground points from each LiDAR data frame of the first plurality of LIDAR data frames; and extracting second ground points from each LiDAR data frame of the second plurality of LIDAR data frames; wherein the first and second ground points are used in calculating the first and second yaw angles. Extracting the first ground points from each LiDAR data frame of the first plurality of LIDAR data frames is performed frame-by-frame of the first plurality of LIDAR data frames, and wherein extracting the second ground points from each LiDAR data frame of the second plurality of LIDAR data frames is performed frame-by-frame of the second plurality of LIDAR data frames. The first ground points are extracted based on being in a region with regard to the vehicle, and wherein the second ground points are extracted based on being in the region with regard to the vehicle. The first plurality of LIDAR data frames is collected during a first session, and wherein the second plurality of LIDAR data frames is collected during a second session. Each of the first and second sessions comprises: extracting lane marker points based on light intensity; fitting a line to the lane marker points; and evaluating a fit of the line to the lane marker points. In response to the fit of the line to the lane marker points not satisfying a criterion, the method further comprises discarding a current frame. The determination whether the first and second yaw angles satisfy the consistency criterion is performed in response to having at least the first and second sessions of the first and second plurality of LIDAR data frames, respectively. Evaluating the fit comprises evaluating a standard deviation of a point-to-line distance. The method further comprises determining whether a threshold number of frames have been accumulated in each session. In response to the consistency criterion not being satisfied, the method further comprises saving a session having a better fit of the line to the lane marker points as a previous session. After saving the session having the better fit as the previous session the method further comprises determining whether a threshold number of frames have been processed. In response to the threshold number of frames having been processed, the method further comprises using a yaw angle from the previous session. The lane marker points correspond to a curved road, and wherein the line fitted to the lane marker points is a curved line. Determining the third yaw angle comprises calculating an average of the first and second yaw angles. The third yaw angle is repeatedly calculated over time and used in calibrating the LiDAR according to a calibration schedule. The third yaw angle is calculated and used in calibrating the LiDAR each time an event is detected by the vehicle. The event comprises that an output of an inertial measurement unit satisfies a criterion.

### BRIEF DESCRIPTION OF DRAWINGS

FIG. 1 shows an example of a method relating to lane-based automatic calibration of a LiDAR, the method performed on a frame.

FIG. 2 shows an example of a method relating to lane-based automatic calibration of a LiDAR, the method performed on multiple frames as part of a session.

FIG. 3 shows an example of a method relating to lane-based automatic calibration of a LiDAR, the method performed regarding multiple sessions.

FIG. 4 shows an example of LiDAR point cloud data before LiDAR calibration according to the present subject matter.

FIG. 5 shows an example of LiDAR point cloud data after LiDAR calibration according to the present subject matter.

FIG. 6 shows an example of calculating a LiDAR misalignment angle for lane-based automatic calibration of a LiDAR on a curved road.

FIG. 7 shows an example of a vehicle.

FIG. 8 illustrates an example architecture of a computing device that can be used to implement aspects of the present disclosure.

Like reference symbols in the various drawings indicate like elements.

### DETAILED DESCRIPTION

This document describes examples of systems and techniques that provide lane-based automatic calibration of a LiDAR on a vehicle. Some implementations provide a solution that automatically calibrates LiDARs on vehicles in real-time by detecting the lane lines and accurately determining the misalignment of the LiDAR. The automatic calibration can compensate for misalignment errors. For example, when a target (e.g., another vehicle, or another object, on the road) is about 100 meters from the vehicle, a misalignment of about one degree in the yaw angle of the LiDAR can result in the ADAS/AD inadvertently placing the target in an incorrect lane. The present subject matter can use accumulated LiDAR point clouds from road lane markers over a relatively short period of time and fit lines to left-side markers and/or to right-side markers. A yaw angle between the fitted line(s) and a longitudinal axis of the LiDAR (defined by a LiDAR coordinate system) can be determined and used in automatically calibrating the LiDAR. The calibration can be performed based on data from only the LiDAR (e.g., no camera signals many be required), and no physical targets such as checkerboards or road landmarks need to be used. Moreover, the processing can require relatively little computing resources, unlike previous approaches such as integrated closest point (ICP). For example, in ICP LiDAR frames are selected and compared against host vehicle odometry to calculate a difference, which may be computationally demanding and/or suffer a lack of convergence when not many fixed vertical features are available. Accordingly, the present subject matter can improve safety of vehicles equipped with ADAS or AD technologies.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle, or the vehicle can be unpowered (e.g., when a trailer is attached to another vehicle). The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether the person is driving the vehicle, or whether the person has access to controls for driving the vehicle, or whether the person lacks controls for driving the vehicle. Vehicles in the present examples are illustrated as being similar or identical to each other for illustrative purposes only.

Examples herein refer to an ADAS. In some implementations, an ADAS can perform assisted driving and/or autonomous driving. An ADAS can at least partially automate one or more dynamic driving tasks. An ADAS can operate based in part on the output of one or more sensors typically positioned on, under, or within the vehicle. An ADAS can plan one or more trajectories for a vehicle before and/or while controlling the motion of the vehicle. A planned trajectory can define a path for the vehicle's travel. As such, propelling the vehicle according to the planned trajectory can correspond to controlling one or more aspects of the vehicle's operational behavior, such as, but not limited to, the vehicle's steering angle, gear (e.g., forward or reverse), speed, acceleration, and/or braking.

While an autonomous vehicle is an example of an ADAS, not every ADAS is designed to provide a fully autonomous vehicle. Several levels of driving automation have been defined by SAE International, usually referred to as Levels 0, 1, 2, 3, 4, and 5, respectively. For example, a Level 0 system or driving mode may involve no sustained vehicle control by the system. For example, a Level 1 system or driving mode may include adaptive cruise control, emergency brake assist, automatic emergency brake assist, lane-keeping, and/or lane centering. For example, a Level 2 system or driving mode may include highway assist, autonomous obstacle avoidance, and/or autonomous parking. For example, a Level 3 or 4 system or driving mode may include progressively increased control of the vehicle by the assisted-driving system. For example, a Level 5 system or driving mode may require no human intervention of the assisted-driving system.

Examples herein refer to a sensor. A sensor is configured to detect one or more aspects of its environment and output signal(s) reflecting the detection. The detected aspect(s) can be static or dynamic at the time of detection. As illustrative examples only, a sensor can indicate one or more of a distance between the sensor and an object, a speed of a vehicle carrying the sensor, a trajectory of the vehicle, or an acceleration of the vehicle. A sensor can generate output without probing the surroundings with anything (passive sensing, e.g., like an image sensor that captures electromagnetic radiation), or the sensor can probe the surroundings (active sensing, e.g., by sending out electromagnetic radiation and/or sound waves) and detect a response to the probing. Examples of sensors that can be used with one or more embodiments include, but are not limited to: a light sensor (e.g., a camera); a light-based sensing system (e.g., a LiDAR device); a radio-based sensor (e.g., radar); an acoustic sensor (e.g., an ultrasonic device and/or a microphone); an inertial measurement unit (e.g., a gyroscope and/or accelerometer); a speed sensor (e.g., for the vehicle or a component thereof); a location sensor (e.g., for the vehicle or a component thereof); an orientation sensor (e.g., for the vehicle or a component thereof); a torque sensor; a thermal sensor; a temperature sensor (e.g., a primary or secondary thermometer); a pressure sensor (e.g., for ambient air or a component of the vehicle); a humidity sensor (e.g., a rain detector); or a seat occupancy sensor.

Examples herein refer to a lane marker. As used herein, a lane marker includes any feature that an ADAS can detect to perceive that a lane ends or begins in any direction. A lane marker includes, but is not limited to, an area of the surface that is visually contrasted from another area of the surface to mark the boundary of a lane (e.g., paint or other pigmented material and/or by a different surface material), a Botts' dot, a so-called turtle, a so-called button, a pavement marker, a rumble strip, a reflective marker, a non-reflective marker, a marker raised above the surface, a marker lowered below the surface, and combinations thereof.

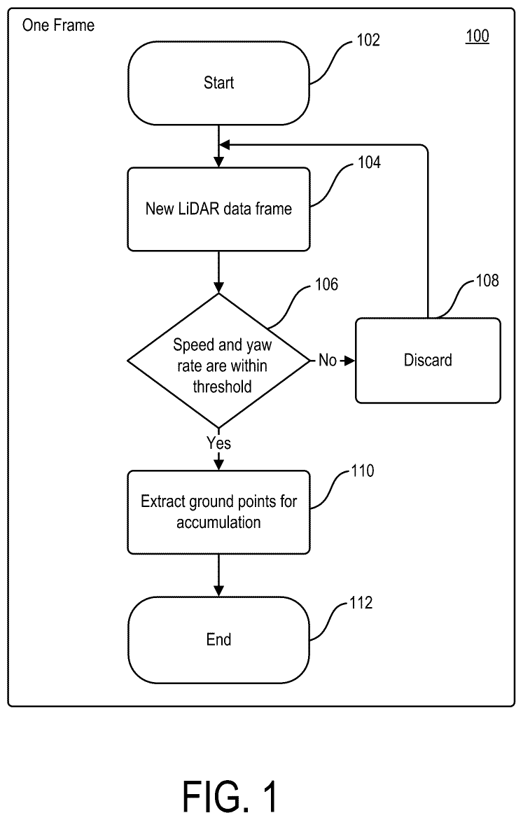

FIG. 1 shows an example of a method 100 relating to lane-based automatic calibration of a LiDAR, the method performed on a frame. The method 100 can be used with one or more other examples described elsewhere herein. More or fewer operations than shown can be performed. Two or more operations can be performed in a different order unless otherwise indicated.

The method 100 can involve processing of a single frame of data from a LiDAR of a traveling vehicle. The LiDAR can continuously be generating output, sometimes referred to as a point cloud, based on registering the reflections of light emitted by the LiDAR. The point cloud indicates, at each instant, the LiDAR-detected surroundings near the vehicle, including the roadway, vehicles or other objects on the road, and structures at the side of the road. As such, the method 100 can be executed repeatedly, substantially in a continuous fashion, while calibration is performed in order to process multiple frames of point cloud data from the LiDAR.

In operation 102, the method 100 can start. In operation 104, a LiDAR data frame can be received. For example, one or more processors of the vehicle (e.g., in any of the vehicle's controllers) can receive a LiDAR data frame generated by the LiDAR.

In operation 106, one or more thresholds can be evaluated. In some implementations, speed data and/or vehicle yaw rate data can be obtained from at least one vehicle controller of the vehicle during travel. A vehicle yaw rate is the change in vehicle yaw angle per unit of time. The vehicle yaw angle is the heading angle of the vehicle with respect to the world coordinate system. The speed data indicates the speed of the vehicle (e.g., based on sensor output indicating wheel speed). In some implementations, it can be determined that the speed data satisfies a speed threshold. For example, the method 100 is performed only when the vehicle is traveling at a threshold speed or faster. In some implementations, it can be determined that the vehicle yaw rate data satisfies a yaw angle threshold. For example, the method 100 is performed only when the vehicle yaw rate is zero or substantially zero. If the outcome of the evaluation in the operation 106 is negative, the method 100 can perform an operation 108. For example, the current frame of LiDAR point cloud data obtained in operation 104 can be discarded. In some implementations, a condition regarding vehicle yaw rate need not be met. As such, an extension may not be limited to only straight sections of roads but can also work when the vehicle travels on a curved road.

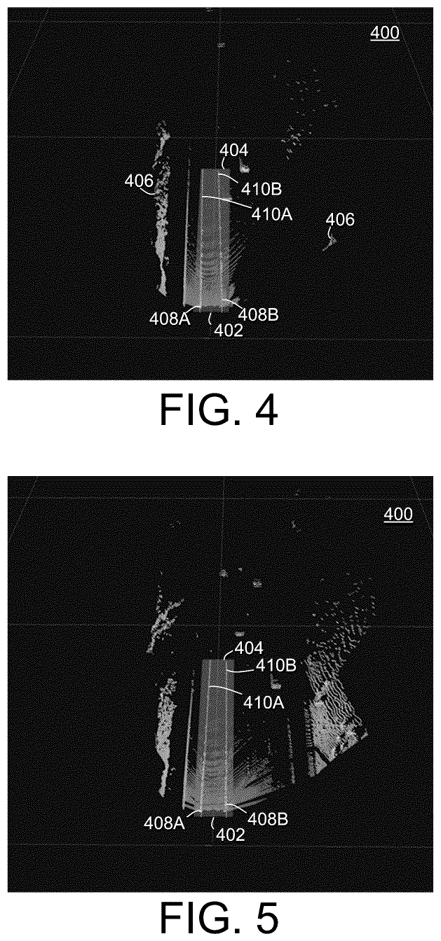

If the outcome of the evaluation in the operation 106 is positive, the method 100 can perform an extraction in operation 110. In some implementations, ground points can be extracted for accumulation. The points that are within a region with regard to the vehicle (e.g., as exemplified in FIGS. 4-5 described below) can be extracted. For example, the region can be a predefined relatively small area ahead of the vehicle in the travel direction. Extracting the ground points can include obtaining LiDAR image information associated with spatial coordinates. As such, the method 100 can result in ground points being extracted from the frame for one or more purposes in the calibration.

The method 100 can end at an operation 112. For example, the method 100 can thereafter be performed again for a new frame of point cloud data from the LiDAR.

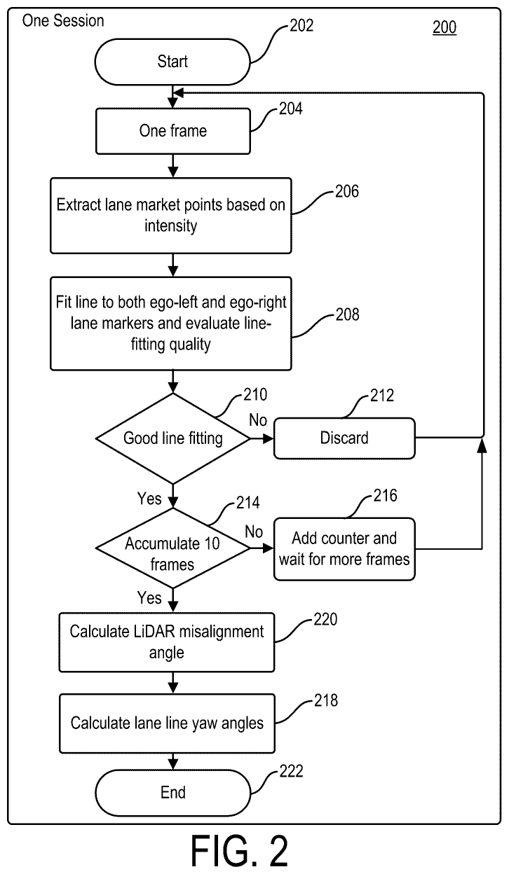

FIG. 2 shows an example of a method 200 relating to lane-based automatic calibration of a LiDAR, the method 200 performed on multiple frames as part of a session. The processing can be done frame-by-frame. The method 200 can be used with one or more other examples described elsewhere herein. More or fewer operations than shown can be performed. Two or more operations can be performed in a different order unless otherwise indicated.

The method 200 can process LiDAR point cloud data that is part of a single session of the calibration, the session based on multiple frames of LiDAR point cloud data. Using multiple frames in the session can improve the line fitting performance. For example, at distances farther from the vehicle the road markers detected by the LiDAR occur more sparsely, so accumulating frames can increase the number of valid LiDAR points. As another example, if the vehicle maneuvers during the calibration session (e.g., by changing lanes) or if the lanes merge or diverge on the road, line fitting quality may temporarily suffer, and the affected frame(s) of LiDAR data can then be rejected without terminating the calibration process.

In operation 202, the method 200 can start. In operation 204, a LiDAR data frame can be processed. For example, one LiDAR data frame can be processed according to the method 100 in FIG. 1. In operation 206, point extraction from among a subset of ground points (e.g., those within a predefined region near the vehicle) can be performed. In some implementations, the extraction is performed based on intensity of light in the LiDAR point cloud. Lane markers may have greater reflectivity than the roadway surface, so by extracting points having at least a threshold intensity, lane marker points can be obtained from the LiDAR point cloud data.

In operation 208, line fitting can be performed to the points extracted in the operation 206. Any of multiple approaches for fitting a line to the points can be used. The resulting line is defined mathematically using coordinates and can represent an approximate linear configuration of the lane markers. In some implementations, line fitting is performed on lane markers to the left of the vehicle (sometimes referred to as ego-left lane markers), and on lane markers to the right of the vehicle (sometimes referred to as ego-right lane markers). The quality of the lane fitting indicates how well the line fits the extracted lane marker points.

In operation 210, the lane fitting quality can be considered. Any of multiple ways of characterizing the quality of the lane fitting can be used. In some implementations, the average distance from each of the extracted lane marker points to the fitted line can be considered. For example, the standard deviation of a point-to-line distance can be used. If the outcome of the evaluation in the operation 210 is negative, the method 200 can perform an operation 212 before returning to the operation 204. For example, the current frame of LiDAR point cloud data obtained in operation 204 can be discarded in operation 212.

If the outcome of the evaluation in the operation 210 is positive, the method 200 can determine in operation 214 whether at least a threshold number of frames have been accumulated in the method 200. The threshold can be ten frames or can be a lower or higher number than ten. In some implementations, yaw angle determination for the session should be performed only when a representative number of frames have been successfully accumulated. If the outcome of the evaluation in the operation 214 is negative, the method 200 in operation 216 can increment a frame counter and wait for the next frame(s), and return to the operation 204.

If the outcome of the evaluation in the operation 214 is positive, the method 200 can determine lane line yaw angles in operation 218. The yaw angles can be calculated for the current session using the accumulated LiDAR frames. The lane line yaw angle(s) can represent the slope, relative to the LiDAR coordinate system, of the line(s) fitted to lane marker points in operation 208.

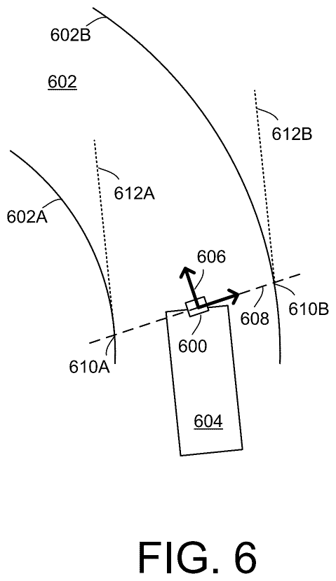

If one has a fitted curve because the vehicle is traveling on a curved road, then the lane line yaw angle can be calculated as the yaw angle of tangents to the fitted curve at starting points in the LiDAR coordinate system. An example is provided below in FIG. 6. A LiDAR misalignment angle can be calculated in operation 220, which can be performed before operation 218. The starting point is where a perpendicular to the vehicle longitudinal axis at the position of the LiDAR coordinate system crosses the lane line. If the lane line yaw angle is nonzero, the lidar is misaligned. Such a misalignment can be zeroed out in software by rotating everything from the LiDAR to the opposite direction of that angle. An assumption in such calculations can be that the vehicle is not skidding; that is, that the vehicle longitudinal axis is parallel to the tangent of the road.

The method 200 can end at an operation 222. For example, the method 200 can thereafter be performed again for a new session, with new frames of point cloud data from the LiDAR.

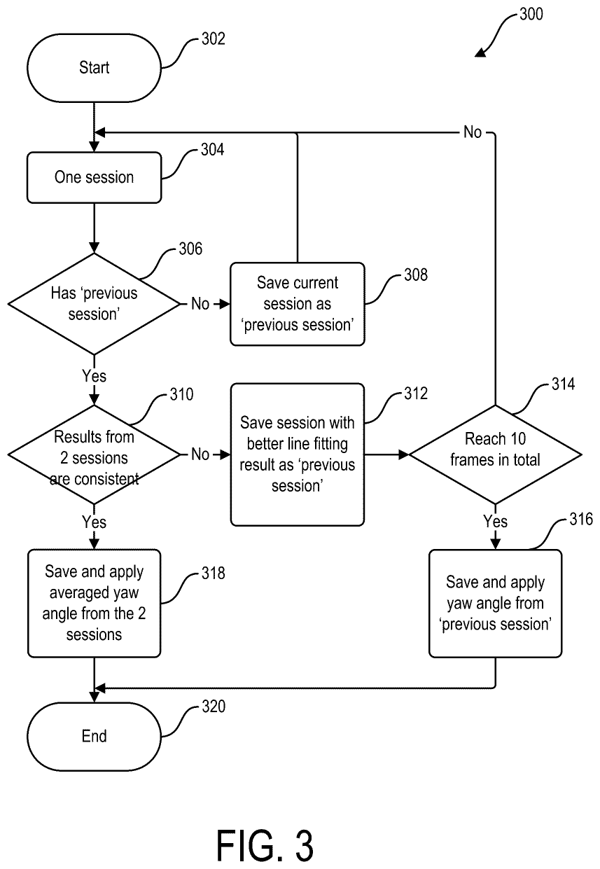

FIG. 3 shows an example of a method 300 relating to lane-based automatic calibration of a LiDAR, the method performed regarding multiple sessions. The method 300 can be used with one or more other examples described elsewhere herein. More or fewer operations than shown can be performed. Two or more operations can be performed in a different order unless otherwise indicated.

In operation 302, the method 300 can start. Performance of the method 300 can be triggered in any of multiple ways. In some implementations, a calibration schedule can be established for the vehicle. For example, the calibration schedule can specify that calibration should be repeatedly performed (e.g., by executing the methods 100, 200, and/or 300 one or more times) at regular intervals or at irregular intervals. In some implementations, event detection can trigger calibration. For example, the output of an inertial measurement unit can indicate an event in response to the vehicle sustaining an impact (e.g., a minor collision such as a fender bender), and calibration can be performed in response to this event.

In operation 304, a session based on multiple LiDAR data frames can be processed. For example, each session can be processed according to the method 200 in FIG. 2.

In operation 306, it can be determined whether the system already has stored a previous session in addition to the session processed in the operation 304. If the outcome of the evaluation in the operation 306 is negative, the method 300 in operation 308 can save the current session (of operation 304) as a previous session, and return to operation 304.

If the outcome of the evaluation in the operation 306 is positive, the method 300 in operation 310 can determine whether the results of multiple sessions satisfy a consistency criterion. The number of sessions can be two or a higher number. In some implementations, the evaluation involves the respective yaw angles calculated for the sessions, and determines whether these values agree with each other or whether they are inconsistent. For example, the yaw angle values can be consistent with each other if they are substantially the same, or at least do not differ from each other by more than a threshold. If the outcome of the evaluation in the operation 310 is negative, the method 300 in operation 312 can save at least one of the sessions as the previous session. In some implementations, the one of the sessions whose line fitting is better (e.g., has the higher quality) can be kept. For example, the session with the lower standard deviation can be used. After operation 312, in operation 314 the method 300 can determine whether a threshold number of frames have been processed. If the outcome of the evaluation in the operation 314 is negative, the method 300 can return to the operation 304 and process an additional session. In some implementations, the operation 314 can be used as an exit criterion in case of poor convergence of the sessions. For example, if the method 300 has not reached convergence (as determined in operation 310) despite processing the threshold number of frames, then the method 300 can exit the processing of operations 304-314 and continue with operation 316, in which the yaw angle for the previous session is applied. For example, this can be the session among the multiple sessions that has the best line fitting quality.

If the outcome of the evaluation in the operation 310 is positive, the method 300 in operation 318 can determine a yaw angle for the LiDAR using the yaw angles of the sessions that are being considered. In some implementations, two sessions (a current session and the previous session) are evaluated for consistency in the operation 310, and if they agree with each other they can be used for determining the yaw angle in the operation 318 that is to be applied in the calibration. For example, the average of the respective yaw angles can be calculated.

The method 300 can end at an operation 320. The yaw angle that was determined in operation 318, or the one resulting from operation 316, can then be applied to calibrate the LiDAR. For example, the point cloud data of the LiDAR can be rotated by the determined yaw angle so as to compensate for misalignment.

FIG. 4 shows an example of LiDAR point cloud data 400 before LiDAR calibration according to the present subject matter. The LiDAR point cloud data 400 can be used with one or more other examples described elsewhere herein.

The LiDAR point cloud data 400 is here shown in a two-dimensional coordinate system and represents the surroundings viewed from above, as detected by the LiDAR, of a vehicle positioned at location 402 and traveling north in the image. A region 404 can be defined relative to a vehicle coordinate system. In some implementations, the region 404 represents the area nearest the vehicle that is of interest regarding performing a calibration of the LiDAR. For example, the region 404 can extend a specified distance forward from the vehicle, and another specified distance toward each side of the vehicle (e.g., sufficiently far to capture the lane markers of the road). The region 404 can have rectangular shape. Point cloud data 406 are examples of points that are included in the LiDAR point cloud data 400 and visible in this example. For example, the point cloud data 406 comes from one frame generated by the LiDAR.

Here, point cloud data 408A-408B are present near the location 402 and are seen to form the beginnings of two substantially straight lines at the bottom of the region 404. The point cloud data 408A-408B have greater intensity than other aspects of the LiDAR point cloud data 400 within the region 404 and represent the presence of lane markers on each side of the vehicle. The LiDAR may detect the lane markers only within a relatively short distance in front of the vehicle. While the point cloud data 406 can come from a single frame, the point cloud data 408A-408B in this example is an accumulation from multiple frames (e.g., because only relatively few lane markers are detected in any individual frame).

Lines can be fitted to the point cloud data 408A-408B so as to extend further from the vehicle than the point cloud data 408A-408B. Here, a line 410A is fitted to the lane marker points of the point cloud data 408A, and a line 410B is fitted to the lane marker points of the point cloud data 408B. For example, this line fitting can be performed in the operation 208 of method 200 in FIG. 2. Here, the lines 410A-410B, and the point cloud data 408A-408B, have a misalignment with reference to the longitudinal axis of the vehicle. This can occur because the LiDAR was not properly aligned when installed, or because the LiDAR has subsequently been brought out of its earlier alignment. As such, the LiDAR of the vehicle should be calibrated.

FIG. 5 shows an example of the LiDAR point cloud data 400 after LiDAR calibration according to the present subject matter. In the calibration, the determined yaw angle (e.g., from operation 318 or 316 of the method 300 in FIG. 3) can be applied to rotate the LiDAR point cloud data 400. As such, the LiDAR point cloud data 400 (which appears different than in FIG. 4 because other LiDAR frames are now being processed) has here been rotated by the yaw angle so that the lines 410A-410B and the point cloud data 408A-408B are aligned with the longitudinal axis of the vehicle. The region 404, on the other hand, which is defined relative to the vehicle coordinate system, is unchanged in this illustration. Accordingly, the present subject matter can provide for automatic LiDAR calibration that is based only on LiDAR data.

FIG. 6 shows an example of calculating a LiDAR misalignment angle for lane-based automatic calibration of a LiDAR 600 on a curved road 602. The present example can be used with one or more other examples described elsewhere herein. The LiDAR 600 is mounted at a front of a vehicle 604 that is traveling on the curved road 602, which has lane lines 602A and 602B on respective sides of the vehicle 604. The lane lines 602A-602B are curved in this example. Curved lines can then be fitted to the lane lines 602A-602B in operation 208 (FIG. 2). Accordingly, lane marker points of the lane lines 602A-602B can correspond to a curved road, and a curved line can be fitted to the lane marker points.

The LiDAR 600 in this example is assumed to be misaligned with regard to the vehicle 604. For example, a LiDAR coordinate system 606 of the LiDAR 600 has its axes misaligned relative to respective longitudinal and transversal axes of the vehicle 604. Based on the LiDAR coordinate system 606, a line 608 can be defined. A starting point 610A can be defined based on where the line 608 crosses the lane line 602A; similarly, a starting point 610B can be defined based on where the line 608 crosses the lane line 602B. A tangent 612A of the lane line 602A can be defined to begin at the starting point 610A; similarly, a tangent 612B of the lane line 602B can be defined to begin at the starting point 610B. The angle of either of the tangents 612A-612B with respect to the LiDAR coordinate system 606 can be the LiDAR misalignment angle.

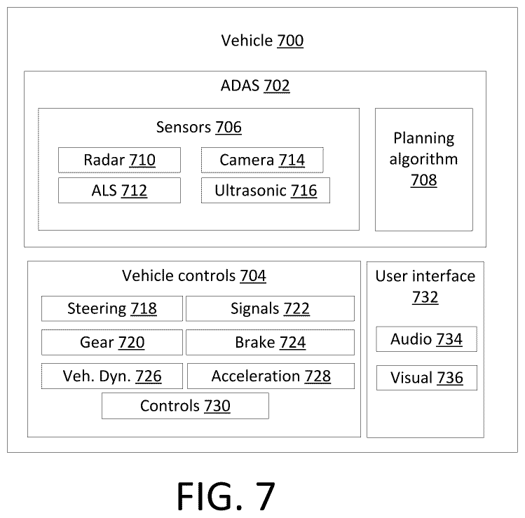

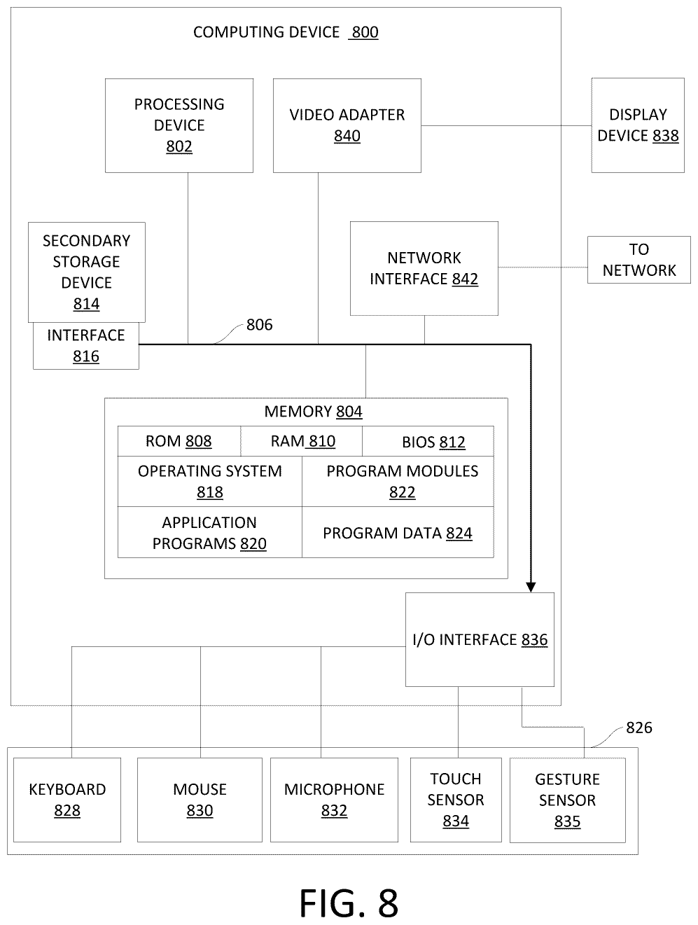

FIG. 7 shows an example of a vehicle 700. The vehicle 700 can be used with one or more other examples described elsewhere herein. The vehicle 700 includes an ADAS 702 and vehicle controls 704. The ADAS 702 can be implemented using some or all components described with reference to FIG. 8 below. The ADAS 702 includes sensors 706 and a planning algorithm 708. Other aspects that the vehicle 700 may include, including, but not limited to, other components of the vehicle 700 where the ADAS 702 may be implemented, are omitted here for simplicity.

The sensors 706 are here described as also including appropriate circuitry and/or executable programming for processing sensor output and performing a detection based on the processing. The sensors 706 can include a radar 710. In some implementations, the radar 710 can include any object detection system that is based at least in part on radio waves. For example, the radar 710 can be oriented in a forward direction relative to the vehicle and can be used for detecting at least a distance to one or more other objects (e.g., another vehicle). The radar 710 can detect the surroundings of the vehicle 700 by sensing the presence of an object in relation to the vehicle 700.

The sensors 706 can include an active light sensor 712. In some implementations, the active light sensor 712 can include any object detection system that is based at least in part on laser light. For example, the active light sensor 712 can be oriented in any direction relative to the vehicle and can be used for detecting at least a distance to one or more other objects (e.g., a lane boundary). The active light sensor 712 can detect the surroundings of the vehicle 700 by sensing the presence of an object in relation to the vehicle 700. The active light sensor 712 can be a scanning LiDAR or a non-scanning LiDAR (e.g., a flash LiDAR), to name just two examples.

The sensors 706 can include a camera 714. In some implementations, the camera 714 can include any image sensor whose signal(s) the vehicle 700 takes into account. For example, the camera 714 can be oriented in any direction relative to the vehicle and can be used for detecting vehicles, lanes, lane markings, curbs, and/or road signage. The camera 714 can detect the surroundings of the vehicle 700 by visually registering a circumstance in relation to the vehicle 700.

The sensors 706 can include an ultrasonic sensor 716. In some implementations, the ultrasonic sensor 716 can include any transmitter, receiver, and/or transceiver used in detecting at least the proximity of an object based on ultrasound. For example, the ultrasonic sensor 716 can be positioned at or near an outer surface of the vehicle. The ultrasonic sensor 716 can detect the surroundings of the vehicle 700 by sensing the presence of an object in relation to the vehicle 700.

Any of the sensors 706 alone, or two or more of the sensors 706 collectively, can detect, whether or not the ADAS 702 is controlling motion of the vehicle 700, the surroundings of the vehicle 700. In some implementations, at least one of the sensors 706 can generate an output that is taken into account in providing an alert or other prompt to a driver, and/or in controlling motion of the vehicle 700. For example, the output of two or more sensors (e.g., the outputs of the radar 710, the active light sensor 712, and the camera 714) can be combined. In some implementations, one or more other types of sensors can additionally or instead be included in the sensors 706.

The planning algorithm 708 can plan for the ADAS 702 to perform one or more actions, or to not perform any action, in response to monitoring of the surroundings of the vehicle 700 and/or an input by the driver. The output of one or more of the sensors 706 can be taken into account. In some implementations, the planning algorithm 708 can perform motion planning and/or plan a trajectory for the vehicle 700.

The vehicle controls 704 can include a steering control 718. In some implementations, the ADAS 702 and/or another driver of the vehicle 700 controls the trajectory of the vehicle 700 by adjusting a steering angle of at least one wheel by way of manipulating the steering control 718. The steering control 718 can be configured for controlling the steering angle though a mechanical connection between the steering control 718 and the adjustable wheel, or can be part of a steer-by-wire system.

The vehicle controls 704 can include a gear control 720. In some implementations, the ADAS 702 and/or another driver of the vehicle 700 uses the gear control 720 to choose from among multiple operating modes of a vehicle (e.g., a Drive mode, a Neutral mode, or a Park mode). For example, the gear control 720 can be used to control an automatic transmission in the vehicle 700.

The vehicle controls 704 can include signal controls 722. In some implementations, the signal controls 722 can control one or more signals that the vehicle 700 can generate. For example, the signal controls 722 can control headlights, a turn signal and/or a horn of the vehicle 700.

The vehicle controls 704 can include brake controls 724. In some implementations, the brake controls 724 can control one or more types of braking systems designed to slow down the vehicle, stop the vehicle, and/or maintain the vehicle at a standstill when stopped. For example, the brake controls 724 can be actuated by the ADAS 702. As another example, the brake controls 724 can be actuated by the driver using a brake pedal.

The vehicle controls 704 can include a vehicle dynamic system 726. In some implementations, the vehicle dynamic system 726 can control one or more functions of the vehicle 700 in addition to, or in the absence of, or in lieu of, the driver's control. For example, when the vehicle comes to a stop on a hill, the vehicle dynamic system 726 can hold the vehicle at standstill if the driver does not activate the brake control 724 (e.g., step on the brake pedal).

The vehicle controls 704 can include an acceleration control 728. In some implementations, the acceleration control 728 can control one or more types of propulsion motor of the vehicle. For example, the acceleration control 728 can control the electric motor(s) and/or the internal-combustion motor(s) of the vehicle 700.

The vehicle controls can further include one or more additional controls, here collectively illustrated as controls 730. The controls 730 can provide for vehicle control of one or more functions or components. In some implementations, the controls 730 can regulate one or more sensors of the vehicle 700. For example, the vehicle 700 can adjust the settings (e.g., frame rates and/or resolutions) of the sensor(s) based on surrounding data measured by the sensor(s) and/or any other sensor of the vehicle 700.

The vehicle 700 can include a user interface 732. The user interface 732 can include an audio interface 734 that can be used for generating an alert regarding a detection. In some implementations, the audio interface 734 can include one or more speakers positioned in the passenger compartment. For example, the audio interface 734 can at least in part operate together with an infotainment system in the vehicle.

The user interface 732 can include a visual interface 736 that can be used for generating an alert regarding a detection. In some implementations, the visual interface 736 can include at least one display device in the passenger compartment of the vehicle 700. For example, the visual interface 736 can include a touchscreen device and/or an instrument cluster display.

FIG. 8 illustrates an example architecture of a computing device 800 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 8 can be used to execute the operating system, application programs, and/or software modules (including the software engines) described herein.

The computing device 800 includes, in some embodiments, at least one processing device 802 (e.g., a processor), such as a central processing unit (CPU). A variety of processing devices are available from a variety of manufacturers, for example, Intel or Advanced Micro Devices. In this example, the computing device 800 also includes a system memory 804, and a system bus 806 that couples various system components including the system memory 804 to the processing device 802. The system bus 806 is one of any number of types of bus structures that can be used, including, but not limited to, a memory bus, or memory controller; a peripheral bus; and a local bus using any of a variety of bus architectures.

Examples of computing devices that can be implemented using the computing device 800 include a desktop computer, a laptop computer, a tablet computer, a mobile computing device (such as a smart phone, a touchpad mobile digital device, or other mobile devices), or other devices configured to process digital instructions.

The system memory 804 includes read only memory 808 and random access memory 810. A basic input/output system 812 containing the basic routines that act to transfer information within computing device 800, such as during start up, can be stored in the read only memory 808.

The computing device 800 also includes a secondary storage device 814 in some embodiments, such as a hard disk drive, for storing digital data. The secondary storage device 814 is connected to the system bus 806 by a secondary storage interface 816. The secondary storage device 814 and its associated computer readable media provide nonvolatile and non-transitory storage of computer readable instructions (including application programs and program modules), data structures, and other data for the computing device 800.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 814 and/or system memory 804, including an operating system 818, one or more application programs 820, other program modules 822 (such as the software engines described herein), and program data 824. The computing device 800 can utilize any suitable operating system.

In some embodiments, a user provides inputs to the computing device 800 through one or more input devices 826. Examples of input devices 826 include a keyboard 828, mouse 830, microphone 832 (e.g., for voice and/or other audio input), touch sensor 834 (such as a touchpad or touch sensitive display), and gesture sensor 835 (e.g., for gestural input). In some implementations, the input device(s) 826 provide detection based on presence, proximity, and/or motion. Other embodiments include other input devices 826. The input devices can be connected to the processing device 802 through an input/output interface 836 that is coupled to the system bus 806. These input devices 826 can be connected by any number of input/output interfaces, such as a parallel port, serial port, game port, or a universal serial bus. Wireless communication between input devices 826 and the input/output interface 836 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 838, such as a monitor, liquid crystal display device, light-emitting diode display device, projector, or touch sensitive display device, is also connected to the system bus 806 via an interface, such as a video adapter 840. In addition to the display device 838, the computing device 800 can include various other peripheral devices (not shown), such as speakers or a printer.

The computing device 800 can be connected to one or more networks through a network interface 842. The network interface 842 can provide for wired and/or wireless communication. In some implementations, the network interface 842 can include one or more antennas for transmitting and/or receiving wireless signals. When used in a local area networking environment or a wide area networking environment (such as the Internet), the network interface 842 can include an Ethernet interface. Other possible embodiments use other communication devices. For example, some embodiments of the computing device 800 include a modem for communicating across the network.

The computing device 800 can include at least some form of computer readable media. Computer readable media includes any available media that can be accessed by the computing device 800. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 800.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 8 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 800 can be characterized as an ADAS computer. For example, the computing device 800 can include one or more components sometimes used for processing tasks that occur in the field of artificial intelligence (AI). The computing device 800 then includes sufficient proceeding power and necessary support architecture for the demands of ADAS or AI in general. For example, the processing device 802 can include a multicore architecture. As another example, the computing device 800 can include one or more co-processors in addition to, or as part of, the processing device 802. In some implementations, at least one hardware accelerator can be coupled to the system bus 806. For example, a graphics processing unit can be used. In some implementations, the computing device 800 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations.

The implementations described herein can include various combinations and/or sub-combinations of the functions, components and/or features of the different implementations described.

What is claimed is:

1. A method of calibration for a vehicle, the method comprising:
obtaining speed data from at least one vehicle controller of the vehicle during travel;
determining that the speed data satisfies a speed threshold;
while the speed threshold is satisfied, and from a light detection and ranging (LiDAR) of the vehicle, collecting first and second pluralities of LIDAR data frames;
calculating a first yaw angle using the first plurality of LIDAR data frames;
calculating a second yaw angle using the second plurality of LIDAR data frames;
determining whether the first and second yaw angles satisfy a consistency criterion;
in response to the consistency criterion being satisfied, determining a third yaw angle for the LiDAR using the first and second yaw angles; and
calibrating the LiDAR using the third yaw angle.

2. The method of claim 1, further comprising obtaining vehicle yaw rate data from the at least one vehicle controller during the travel, and determining that the vehicle yaw rate data satisfies a yaw rate threshold, wherein the first and second pluralities of LIDAR data frames are collected while also the yaw rate threshold are satisfied.

3. The method of claim 2, wherein in response to at least one of the speed threshold or the yaw rate threshold not being satisfied, the method further comprises discarding LiDAR data.

4. The method of claim 3, wherein collecting the first and second pluralities of LIDAR data frames comprises:
extracting first ground points from each LiDAR data frame of the first plurality of LIDAR data frames; and
extracting second ground points from each LiDAR data frame of the second plurality of LIDAR data frames;
wherein the first and second ground points are used in calculating the first and second yaw angles.

5. The method of claim 4, wherein extracting the first ground points from each LiDAR data frame of the first plurality of LIDAR data frames is performed frame-by-frame of the first plurality of LIDAR data frames, and wherein extracting the second ground points from each LiDAR data frame of the second plurality of LIDAR data frames is performed frame-by-frame of the second plurality of LIDAR data frames.

6. The method of claim 4, wherein the first ground points are extracted based on being in a region with regard to the vehicle, and wherein the second ground points are extracted based on being in the region with regard to the vehicle.

7. The method of claim 1, wherein the first plurality of LIDAR data frames is collected during a first session, and wherein the second plurality of LIDAR data frames is collected during a second session.

8. The method of claim 7, wherein each of the first and second sessions comprises:
extracting lane marker points based on light intensity;
fitting a line to the lane marker points; and
evaluating a fit of the line to the lane marker points.

9. The method of claim 8, wherein in response to the fit of the line to the lane marker points not satisfying a criterion, the method further comprises discarding a current frame.

10. The method of claim 8, wherein the determination whether the first and second yaw angles satisfy the consistency criterion is performed in response to having at least the first and second sessions of the first and second plurality of LIDAR data frames, respectively.

11. The method of claim 8, wherein evaluating the fit comprises evaluating a standard deviation of a point-to-line distance.

12. The method of claim 8, further comprising determining whether a threshold number of frames have been accumulated in each session.

13. The method of claim 8, wherein in response to the consistency criterion not being satisfied, the method further comprises saving a session having a better fit of the line to the lane marker points as a previous session.

14. The method of claim 13, wherein after saving the session having the better fit as the previous session the method further comprises determining whether a threshold number of frames have been processed.

15. The method of claim 14, wherein in response to the threshold number of frames having been processed, the method further comprises using a yaw angle from the previous session.

16. The method of claim 8, wherein the lane marker points correspond to a curved road, and wherein the line fitted to the lane marker points is a curved line.

17. The method of claim 1, wherein determining the third yaw angle comprises calculating an average of the first and second yaw angles.

18. The method of claim 1, wherein the third yaw angle is repeatedly calculated over time and used in calibrating the LiDAR according to a calibration schedule.

19. The method of claim 1, wherein the third yaw angle is calculated and used in calibrating the LiDAR each time an event is detected by the vehicle.

20. The method of claim 19, wherein the event comprises that an output of an inertial measurement unit satisfies a criterion.
